(19) United States
(12) Patent Application Publication
(10) Pub. No.: US 2015/0310780 A1
(43) Pub. Date: Oct. 29, 2015

(54) Three-dimensional Advertising Display

(71) Applicant: Benjamin W. Anders, Henderson, NV (US)

(72) Inventor: Benjamin W. Anders, Henderson, NV (US)

(21) Appl. No.: 14/461,247

(22) Filed: Aug. 15, 2014

Related U.S. Application Data
(60) Provisional application No. 61/983,689, filed on Apr. 24, 2014.

(51) Int. Cl. G09F 19/22; G09F 7/00

(52) U.S. Cl. CPC G09F 19/228; G09F 7/00

(57) ABSTRACT

A three-dimensional advertising display is provided. The present invention relates to outdoor advertising displays that correctly show directions to an event when viewed from more than two approaching directions.

### FIELD OF THE INVENTION

The present invention relates generally to the field of advertising. More specifically, the present invention relates to a three-dimensional advertising display which is meant to enable small-scale street side advertising, ideal for advertising events such as real estate sales, garage sales, yard sales, moving sales, car washes, items for rent, and even large or gatherings requiring signage for temporary traffic flow.

### BACKGROUND OF THE INVENTION

Advertising is any communication intended to convey information about a product or event. To be effective, advertising must be delivered in a concise and impactful manner, such that even a passing glance, or a moment of attention is all that is necessary to spark an interest in what is being promoted. Advertising exists to provide people with information about products, opportunities, and services that they may not have known about or that they might not currently be considering to purchase or engage in prior to receiving or seeing the advertising.

Outdoor advertising includes any kind of promoting of products or services which occurs in an outdoor environment. Some examples of outdoor advertising includes billboards, signs, posters, and flyers. Compared to more expensive media and advertising campaigns, outdoor advertising with signage is relatively cheap, and is thus particularly useful as an advertising medium for small businesses. Additionally, outdoor advertising can be done on a smaller, more limited scale than widespread circulation or broadcast of an advertisement through print, the internet, or radio waves.

Placing a two-dimensional sign by the roadside to indicated an item for sale is one way to draw in potential buyers. In such a case, the sign may include a directional arrow to indicate where the item is being sold. One problem with this form of advertising is that the sign is only viewable from a maximum of two directions. Thus, if such a sign were to be placed at an intersection then only traffic from two directions would be able to see the sign and respond appropriately to the directional arrow.

The present invention introduces a new form of outdoor signage which is ideal for small scale advertising and is particularly effective at indicating directions to help guide potential customers or participants of an event on a specific route. It is an object of the present invention to create a new type of sign capable of easily and correctly indicating the directions to an event, sale, or other type of function to incoming traffic from more than two different angles. The present invention accomplishes this by possessing a unique sign surface which is in the shape of a cube and thereby is visible from more than two different traffic directions. It is a further object of the present invention to provide an economical form of outdoor advertising that is professional in appearance and easy to deploy.

### BRIEF DESCRIPTION OF THE DRAWINGS

Various embodiments of the present invention are shown and described in reference to the numbered drawings wherein:

FIG. 1 is a perspective view of the present invention;

FIG. 2 is a front view thereof;

FIG. 3 is a right side view thereof;

FIG. 4 is a left side view thereof;

FIG. 5 is a rear view thereof;

FIG. 6 is a top view thereof;

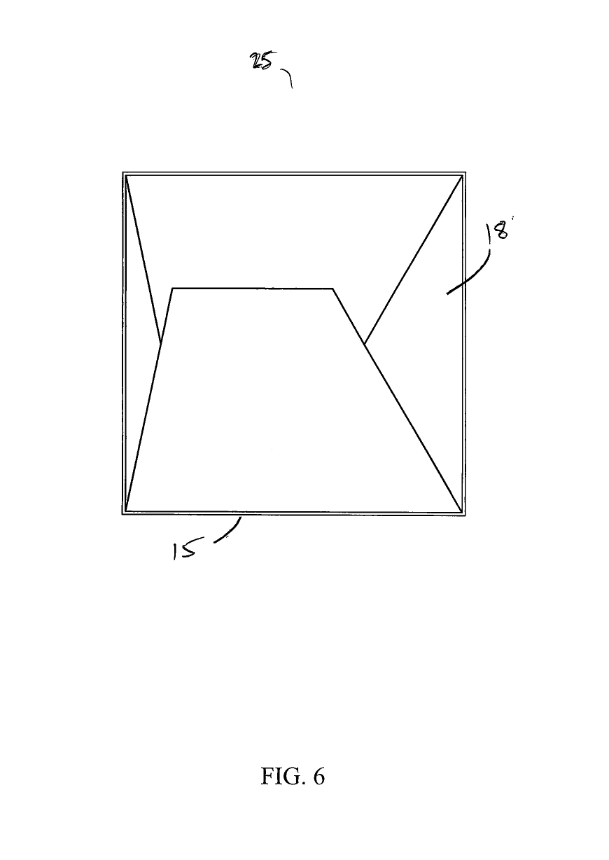

FIG. 7 is a bottom view thereof.

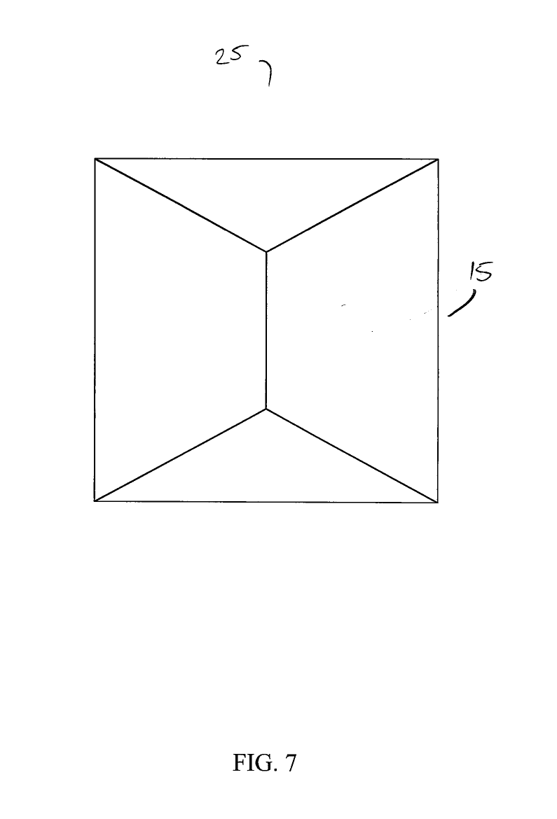

FIG. 8 is a front view of the present invention unfolded into a flat panel;

FIG. 9. is a perspective view thereof.

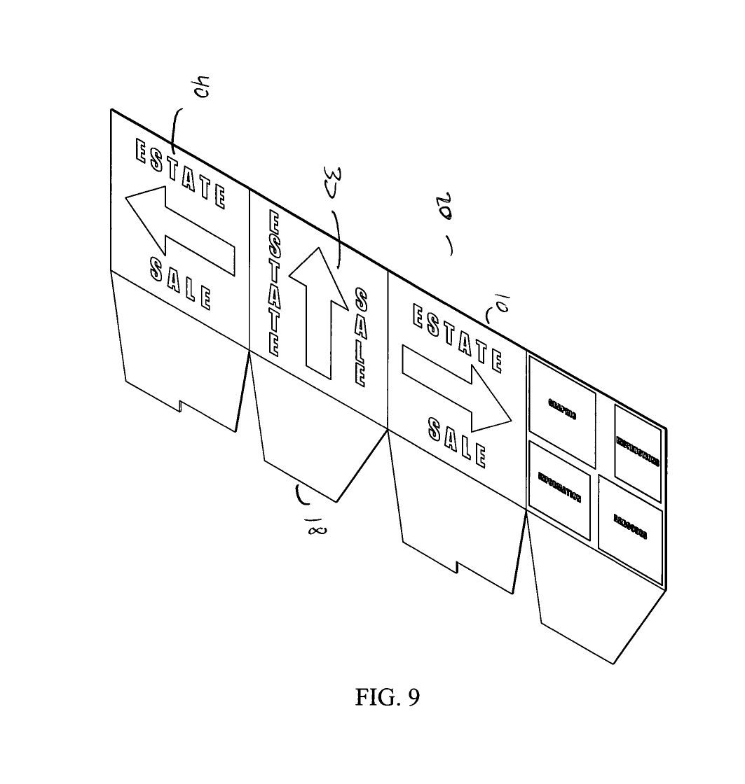

FIG. 10 is a front view of an alternative embodiment of the present invention unfolded into a flat panel.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity.

### SUMMARY OF THE INVENTION

The present invention is a 3-dimensional box advertisement which is specifically adapted to be placed at intersections of roads. The advantage of the present invention over the prior art is that it is capable of indicating a desired direction to incoming traffic from more than two different angles. This maximizes the number of people who are able to see the advertisement at any given time, and ensures that those coming into the intersection are informed of the direction in which they must travel in order to reach the subject of the advertisement. Typically, three directions are necessary since the traffic coming in from the fourth direction is assumed to have passed near to the location of the subject of the advertisement where they likely saw the subject itself or saw other advertisements. An alternative embodiment of the invention can also include four sides to cover all four directions, with one of the sides indicating a U-turn arrow. The present invention can also be used for intentions other than advertising, including but not limited to marking marathon routes, indicating sporting events, and providing basic directional guidance such as to new students on a college campus.

### DETAILED DESCRIPTION OF THE INVENTION

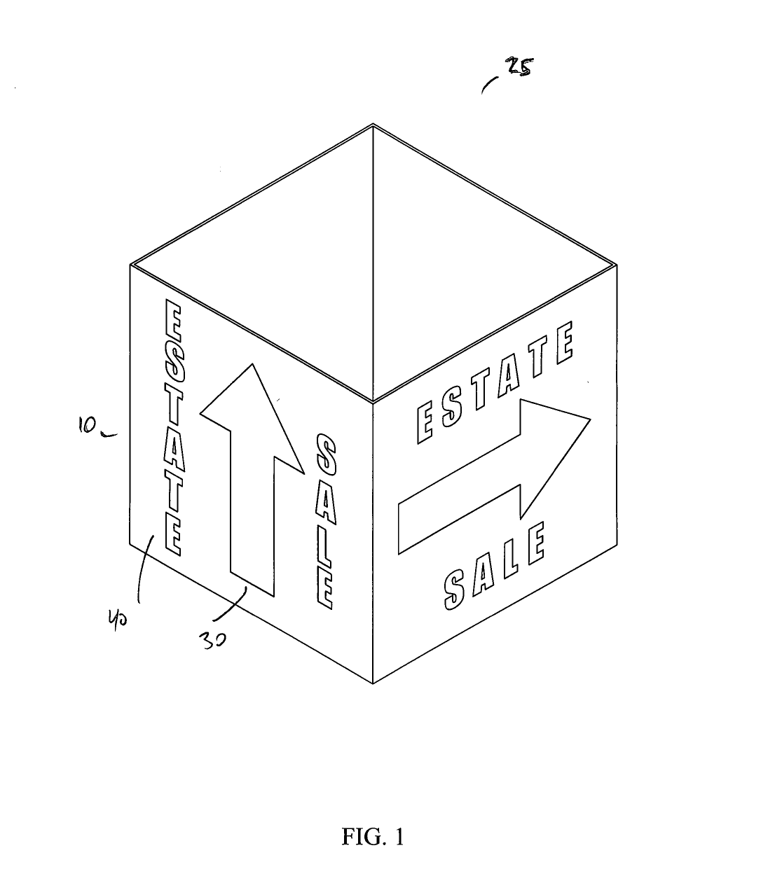

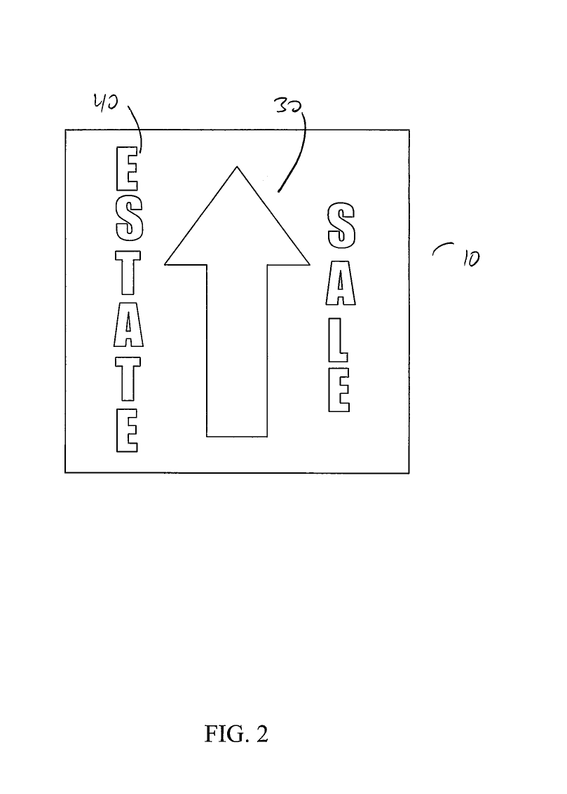

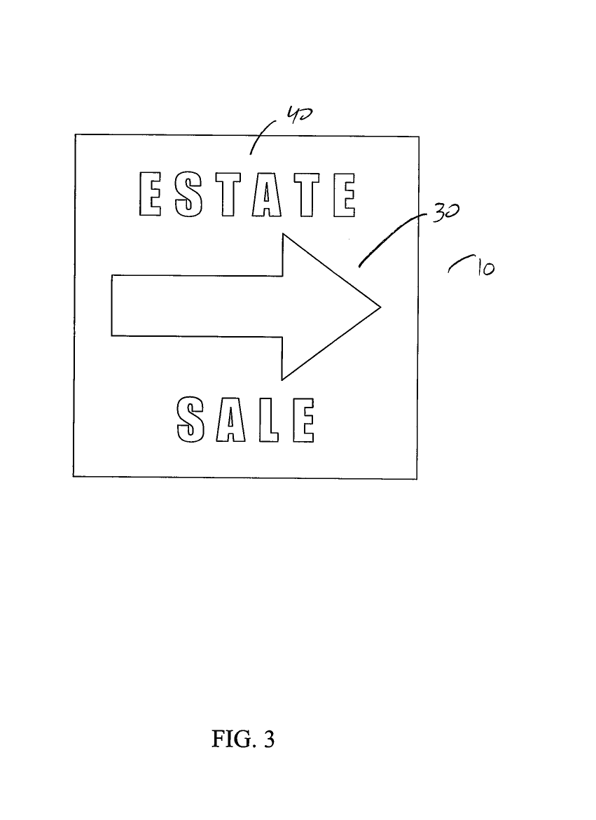

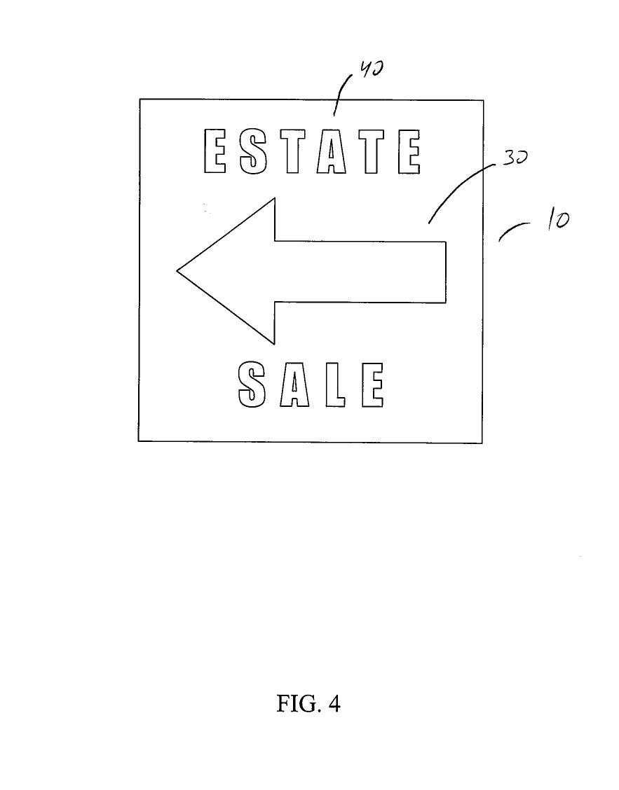

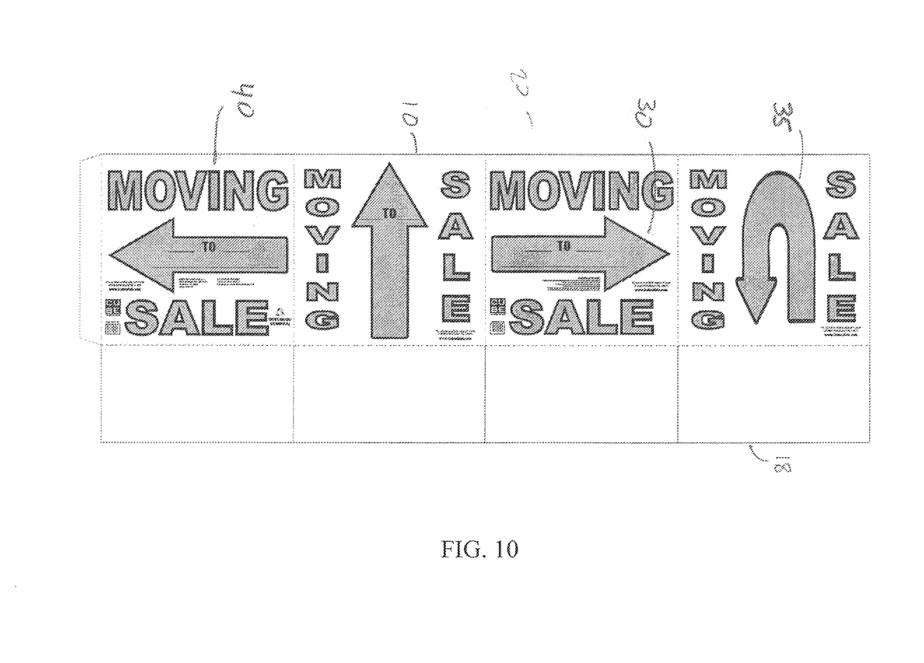

The present invention comprises a plurality of side panels 10 and a bottom surface 15. The plurality of side panels 10 are all interconnected and comprise the same continuous sheet 20 of material. When the plurality of side panels 10 are bent such that each panel is ninety degrees to the two adjacent panels, a box 25 is formed as can be seen in FIG. 1. Each of the plurality of side panels 10 is approximately square in geometric shape, but any size and dimension of side panels 10 is appropriate within the spirit of the present invention. Additionally, the preferred embodiment of the present invention possesses four distinct side panels, thus forming a cube or rectangular shape when the plurality of side panels are folded into the correct position. This can be seen in FIG. 1. In one embodiment of the invention, three of the four side panels 10 bear a directional arrow 30. In a preferred embodiment of the invention, three of the four side panels 10 bear straight directional arrows 30, while the fourth side panel bears a u-turn directional arrow 35. Directional arrows 30 and u-turn arrow 35 each indicate unique directions such that the box 25 can correctly indicate proper traffic directions when viewed from more than two oncoming directions. For example, FIG. 2 shows one of the plurality of side panels 10 with a directional arrow 30 pointing upwards. This is widely accepted to indicated the forwards direction when piloting a ground vehicle such as a car. The two remaining panels bearing directional arrows 30 can be seen in FIG. 3 and FIG. 4 and are suitable to indicate the same direction of the first panel by using properly oriented arrows. An alternative embodiment as shown in FIG. 10 comprises a fourth side panel 10 for a u-turn. According to one embodiment of the present invention, the u-turn direction is indicated by u-turn arrow 35.

According to the invention, the directional arrows 30 or 35 are uniquely oriented such that each side panel 10 correctly indicates the proper direction of travel when box 25 is fixedly located. Thus, when the present invention is placed at an intersection, the traffic incoming from more than two angles, even three or four angles, can all view the advertisement and are instructed with the correct direction through the varying orientation of each directional arrow 30 and 35 on side panels 10. In addition to directional arrows 30 and 35, side panels 10 may also bear a short message 40 which is intended to convey some information about the type of product, service, or event being advertised. For example, the figures included with this specification show the plurality of side panels 10 with the words “Estate Sale.” This indicates that a property is for sale. Thus the present invention is capable of correctly indicating both message and directional information when viewed from more than two directions. The message 40 present on side panels 10 will vary depending on what is being advertised, and is in no way limited by the example shown in the figures.

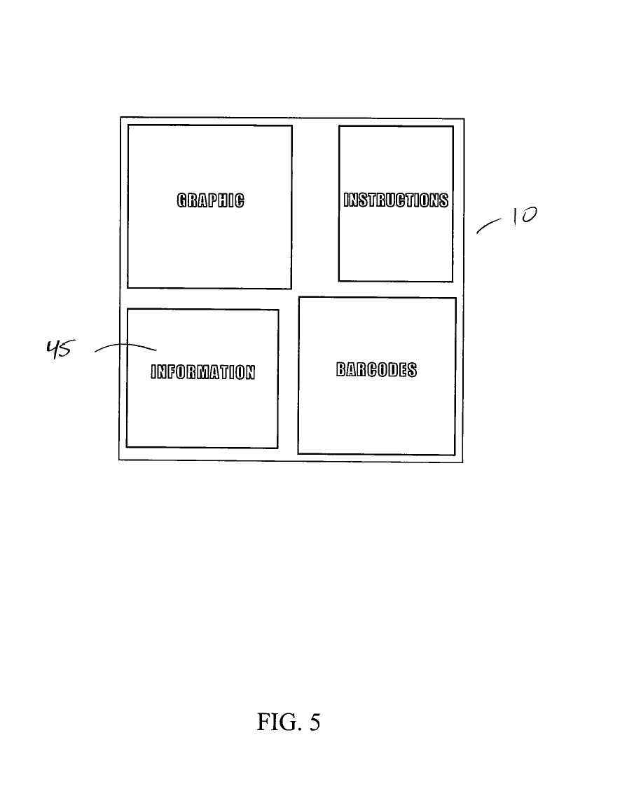

In another embodiment of the invention, one of the four side panels 10, as seen in FIG. 5, may indicate point-of-sale information 45 about box 25 such as instructions for setting up the box, bar codes for store scanning, a graphic detailing folding and setup instructions, and contact information for the manufacturer. The plurality of side panels 10 may be comprised of any foldable material including but not limited to cardboard, paper, and plastic. Although the preferred embodiment of the present invention utilizes four side panels, it is conceivable that the present invention could be redesigned to take other shapes when deployed, including but not limited to polygons, circles, and irregular shapes.

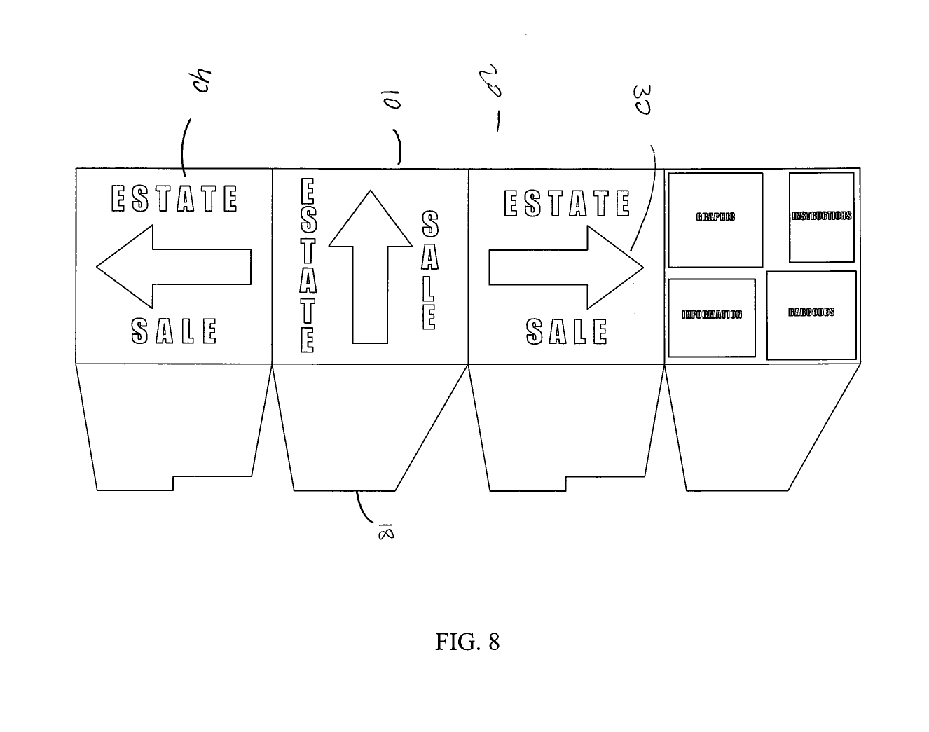

In a preferred embodiment, the bottom surface 15 comprises a plurality of bottom panels 18, each of which is attached to a corresponding side panel. This is illustrated clearly in FIG. 8 which displays the present invention in the flattened state. Since the present invention is manufactured from a foldable material, it is ideal to manufacture and ship the present invention in the flattened state, and only have it deployed into box form, FIG. 1, when it is in use. The bottom surface 15 is included in order to provide a way to secure the present invention to the ground. This is imperative as the present invention is manufactured from light materials and is susceptible to wind forces displacing the present invention. To prevent this, it is recommended that a heavy object be placed within the present invention on top of the bottom surface, thereby pinning bottom surface 15 to the ground and holding the present invention in place. In the preferred embodiment, bottom panels 18 are configured into what is known as an auto locking bottom, a technology that is well known in the packaging field. Each of the plurality of bottom panels 18 is specifically shaped such that they interlock when they are folded upwards to form bottom surface 15. Thus, bottom surface 15 is capable of holding the present invention in place when the heavy object is placed within box 25. The plurality of bottom panels 18 are directly connected to the plurality of side panels 10 as seen in FIG. 8, and comprise the same continuous piece of material 20 which is then folded into shape. The plurality of bottom panels 18 may also include some adhesives applied to their surfaces in order to further fix the plurality of bottom panels into position to form bottom surface 15. FIG. 10 shows an alternative embodiment of the present invention unfolded into a flat panel.

The present invention further includes providing a lid for box 25 that can be placed on top of the of the box or, alternatively, can be formed integral to continuous sheet 20 and folded into the overall box arrangement. The lid can be shaped in a variety of fashions, some of which may uniquely portray the event being advertised. For example, the lid could be shaped like the roof of a house and used to more effectively connote real property or house sales.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. An advertising display comprising:
a plurality of side panels configured for arrangement into a three-dimensional shape;
directional arrows indicated on said side panels wherein each directional arrow presents a unique direction of travel when said side panels are arranged into said three-dimensional shape; and
a message indicated on said side panels in conjunction with said directional arrows.

2. The advertising display of claim 1, wherein said side panels have a length and a width and said lengths are equal and said widths are equal.

3. The advertising display of claim 1, wherein said side panels have bottom portions configured for arrangement into a bottom surface.

4. The advertising display of claim 3, wherein said bottom surface is configured to receive a weighted object to hold said advertising display in a fixed position.

5. The advertising display of claim 1 wherein one of said directional arrows is a u-turn arrow.

6. The advertising display of claim 1 further comprising a top configured for placement above said side panels when said advertising display is shaped into a three dimensional shape.

7. The advertising display of claim 1 wherein said side panels are formed from a continuous sheet of foldable material.

8. The advertising display of claim 4 wherein said side panels are formed from a continuous sheet of foldable material.

9. The advertising display of claim 3 wherein said bottom portions are provided with adhesive material for securing said side panels into a three-dimensional shape.

10. The advertising display of claim 5 wherein said side panels have bottom portions configured for arrangement into a bottom surface configured to receive a weighted object to hold said advertising display in a fixed position.
